(19) United States
(12) Patent Application Publication
(10) Pub. No.: US 2010/0118981 A1
(43) Pub. Date: May 13, 2010

(54) METHOD AND APPARATUS FOR MULTI-LATTICE SPARSITY-BASED FILTERING

(75) Inventors: Oscar Divorra Escoda, Princeton, NJ (US); Peng Yin, West Windsor, NJ (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/451,962

(22) PCT Filed: May 29, 2008
(86) PCT No.: PCT/US2008/006809

§ 371 Date: Dec. 8, 2009

Related U.S. Application Data
(60) Provisional application No. 60/942,677, filed on Jun. 8, 2007.

(51) Int. Cl. H04N 7/32; G06K 9/40

(52) U.S. Cl. 375/240.29; 382/260; 375/E07.193

(57) ABSTRACT

There are provided a method and apparatus for multi-lattice sparsity-based filtering. The apparatus includes a filter for filtering picture data for a picture to generate an adapted weighted combination of at least two filtered versions of the picture. The picture data includes at least one sub-sampling of the picture.

### CROSS-REFERENCE TO RELATED APPLICATIONS

This application claims the benefit of U.S. Provisional Application Ser. No. 60/942,677, filed 8 Jun., 2007, which is incorporated by reference herein in its entirety.

### TECHNICAL FIELD

The present principles relate generally to image filtering and, more particularly, to a method and apparatus for multi-lattice sparsity-based filtering.

### BACKGROUND

General purpose robust filtering of images is essential for many applications where one needs to generate a more accurate estimate of an image out of a less accurate signal issued from any digital procedure such as, for example, prediction, compression, up-scaling, acquisition, and so forth.

Many digital processes introduce noise, artifacts and/or other types of distortions into images. For this purpose, robust filtering based on sparse approximations can be used. Typically such filtering using sparse approximations involves the procedures of: signal transformation; thresholding of transformed signal coefficients (which involves, for example, setting to zero all those coefficients below a given value); and transformation back to the spatial domain.

For this purpose, complete and/or over-complete transforms can be used. Transforms have a limited number of principal directions. This means that basis functions in transforms have oriented features on a limited number of directions. As an example, basis functions of the 2D DCT (2-Dimensional Discrete Cosine Transform) have two main directions on the rectangular sampling grid used for images and video: vertical and horizontal. This is a hard limitation, as once a transform is defined, the capacity of efficiently filtering signal structures in images having other directions than the pure “native” directions of the used transform (e.g., diagonal edges, oriented textures, and so forth) is limited.

In a first prior art approach, an adaptive filtering for image denoising is proposed based on the use of redundant transforms. In the first prior art approach, the redundant transforms are generated by all the possible translations Hᵢ of a given transform H. Hence, given an image I, a series of different transformed versions Yᵢ of the image I are generated by applying the transforms Hᵢ on I. Every transformed version Yᵢ is then processed by means of a coefficients denoising procedure (usually a thresholding operation) in order to reduce the noise included in the transformed coefficients. This generates a series of Y′ᵢ. After that, each Y′ᵢ is transformed back into the spatial domain becoming different estimates where there should be, in each of them, a lower amount of noise. The first prior art approach exploits also the fact that different I′ᵢ include the best denoised version of I for different locations. Hence, it estimates the final filtered version I′ as a weighted sum of I′ᵢ where the weights are optimized such that the best I′ᵢ is favored at every location of I′. FIGS. 1 and 2 relate to this first prior art approach.

Turning to FIG. 1, an apparatus for position adaptive sparsity based filtering of pictures in accordance with the prior art is indicated generally by the reference numeral 100.

The apparatus 100 includes a first transform module (with transform matrix 1) 105 having an output connected in signal communication with an input of a first denoise coefficients module 120. An output of the first denoise coefficients module 120 is connected in signal communication with an input of a first inverse transform module (with inverse transform matrix 1) 135, an input of a combination weights computation module 150, and an input of an Nth inverse transform module (with inverse transform matrix N) 145. An output of the first inverse transform module (with inverse transform matrix 1) 135 is connected in signal communication with a first input of a combiner 155.

An output of a second transform module (with transform matrix 2) 110 is connected in signal communication with an input of a second denoise coefficients module 125. An output of the second denoise coefficients module 125 is connected in signal communication with an input of a second inverse transform module (with inverse transform matrix 2) 140, the input of the combination weights computation module 150, and the input of the Nth inverse transform module (with inverse transform matrix N) 145. An output of the second inverse transform module (with inverse transform matrix 2) 140 is connected in signal communication with a second input of the combiner 155.

An output of an Nth transform module (with transform matrix N) 115 is connected in signal communication with an input of an Nth denoise coefficients module 130. An output of the Nth denoise coefficients module 130 is connected in signal communication with an input of the Nth inverse transform module (with inverse transform matrix N) 145, the input of the combination weights computation module 150, and the input of the first inverse transform module (with inverse transform matrix 1) 135. An output of the Nth inverse transform module (with inverse transform matrix N) 145 is connected in signal communication with a third input of the combiner 155.

An output of the combination weight computation module 150 is connected in signal communication with a fourth input of the combiner 155.

An input of the first transform module (with transform matrix 1) 105, an input of the second transform module (with transform matrix 2) 110, and an input of the Nth transform module (with transform matrix N) 115 are available as inputs of the apparatus 100, for receiving an input image. An output of the combiner 155 is available as an output of the apparatus 100, for providing an output image.

Turning to FIG. 2, a method for position adaptive sparsity based filtering of pictures in accordance with the prior art is indicated generally by the reference numeral 200.

The method 200 includes a start block 205 that passes control to a loop limit block 210. The loop limit block 210 performs a loop for every value of variable i, and passes control to a function block 215. The function block 215 performs a transformation with transform matrix i, and passes control to a function block 220. The function block 220 determines the denoise coefficients, and passes control to a function block 225. The function block 225 performs an inverse transformation with inverse transform matrix i, and passes control to a loop limit block 230. The loop limit block 230 ends the loop over each value of variable i, and passes control to a function block 235. The function block 235 combines (e.g., locally adaptive weighted sum of) the different inverse transformed versions of the denoised coefficients images, and passes control to an end block 299.

Weighting approaches can be various and they may depend at least on one of a data to be filtered, the transforms used on the data and statistical assumptions on the noise/distortion to filter.

The first prior art approach considers each Hᵢ as an orthonormal transform. Moreover, it considers each Hᵢ to be a translated version of a given 2D orthonormal transform, such as wavelets or DCT. Taking this into account, the first prior art approach does not consider the fact that a given orthonormal transform has a limited amount of directions of analysis. Hence, even if all possible translations of the DCT are used to generate an over-complete representation of I, I will be decomposed uniquely into vertical and horizontal components, independently of the particular components of I.

A second prior art approach does not introduce any new concept with respect to the first prior art approach, simply the same algorithm from the first prior art approach is applied for In-loop artifact filtering in a Hybrid video coding framework such as the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”).

In a third prior art approach, it is proposed within the framework of wavelet image coding to use lattice sub-sampling of images in order to perform wavelet filtering in those sub-lattices in order to achieve oriented wavelet decompositions. In the third prior art approach, a set of systematic sampling patterns are defined on images, and then wavelet filtering is performed only on the sub-sampled version of the images. Wavelet filtering is performed along the main directions of such sampling patterns.

The third prior art approach presents a way of using such sub-sampling of an image for oriented wavelet transformation. A particular example of how to use the proposed sub-sampling is to re-arrange each sub-sampled grid with a rotation, such that each sub-sampled grid is turned into a rectangular sampling grid. Then, regular separable wavelet filtering on each newly generated rectangular sampling grid will naturally generate oriented wavelet filtering in the direction of the originally, non-rearranged, sampling grid. This avoids the need of redefining special wavelet transforms on the original rectangular sampling grid when oriented wavelets are desired.

A fourth prior art approach presents a Fourier transform formulated on a quincunx lattice. However, the fourth prior art approach does not present any further application of such a transform nor combination with any other transform.

In a fifth prior art approach, a transform is presented that has a large variety of directions of analysis in order to cope with a huge variety of signal oriented features. However, its use, definition and computational handling are difficult, tedious and complex, which makes it mostly unsuitable for current video coding standards.

### SUMMARY

These and other drawbacks and disadvantages of the prior art are addressed by the present principles, which are directed to a method and apparatus for multi-lattice sparsity-based filtering.

According to an aspect of the present principles, there is provided an apparatus. The apparatus includes a filter for filtering picture data for a picture to generate an adaptive weighted combination of at least two filtered versions of the picture. The picture data includes at least one sub-sampling of the picture.

According to another aspect of the present principles, there is provided a method. The method includes filtering picture data for a picture to generate at least two filtered versions of the picture. The picture data includes at least one sub-sampling of the picture. The method further includes calculating an adaptive weighted combination of the at least two filtered versions of the picture.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an apparatus for position adaptive sparsity based filtering of pictures, in accordance with the prior art;

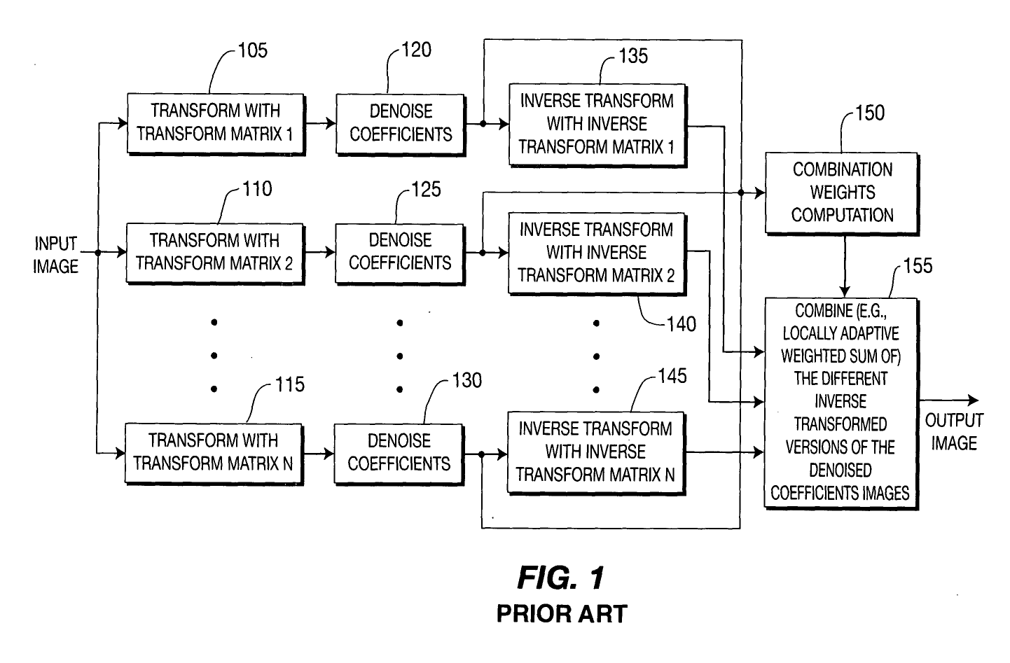

FIG. 2 is a flow diagram for a method for position adaptive sparsity based filtering of pictures, in accordance with the prior art;

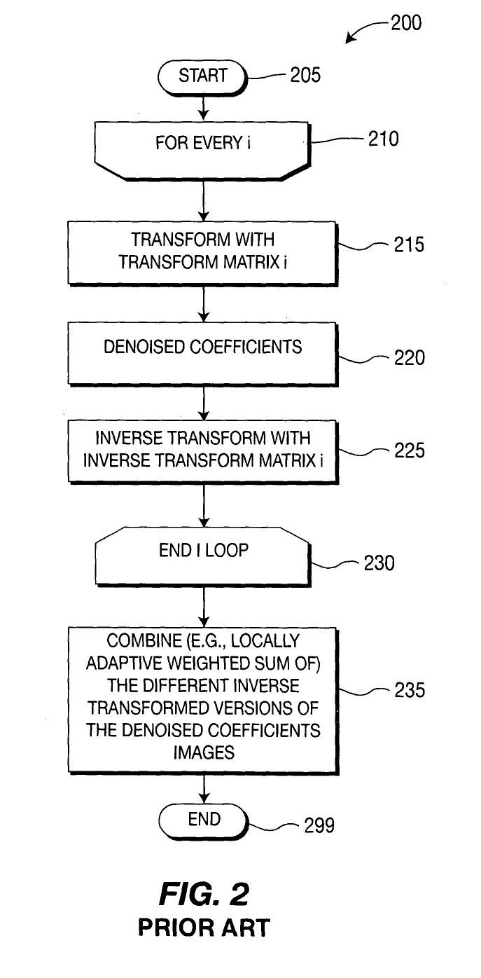

FIG. 3 is a high-level block diagram for an exemplary position adaptive sparsity based filter for pictures with multi-lattice signal transforms, in accordance with an embodiment of the present principles;

FIG. 4 is a high-level block diagram for another exemplary position adaptive sparsity based filter for pictures with multi-lattice signal transforms, in accordance with an embodiment of the present principles;

FIG. 5 is a high-level block diagram for yet another exemplary position adaptive sparsity based filter for pictures with multi-lattice signal transforms, in accordance with an embodiment of the present principles;

FIG. 6 is a diagram for Discrete Cosine Transform (DCT) basis functions and their shapes included in a DCT of 8×8 size, to which the present principles may be applied, in accordance with an embodiment of the present principles;

FIGS. 7A and 7B are diagram showing examples of lattice sampling with corresponding lattice sampling matrices, to which the present principles may be applied, in accordance with an embodiment of the present principles;

FIG. 8 is a diagram for an exemplary down-sampled rectangular grid to which every coset in any such sampling lattice may be re-arranged, in accordance with an embodiment of the present principles;

FIG. 9 is a flow diagram for an exemplary method for position adaptive sparsity based filtering of pictures with multi-lattice signal transforms, in accordance with an embodiment of the present principles; and

FIGS. 10A-10D are diagram for a respective one of four of the 16 possible translations of a 4×4 DCT transform, to which the present principles may be applied, in accordance with an embodiment of the present principles.

### DETAILED DESCRIPTION

The present principles are directed to a method and apparatus for multi-lattice sparsity-based filtering.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As used herein, the term “picture” refers to images and/or pictures including images and/or pictures relating to still and motion video.

Moreover, as used herein, the term “sparsity” refers to the case where a signal has few non-zero coefficients in the transformed domain. As an example, a signal with a transformed representation with 5 non-zero coefficients has a sparser representation than another signal with 10 non-zero coefficients using the same transformation framework.

Further, as used herein, the terms “lattice” or “lattice-based”, as used with respect to a sub-sampling of a picture, refers to a sub-sampling where samples would be selected according to a given structured pattern of spatially continuous and/or non-continuous samples. In an example, such pattern may be a geometric pattern such as a rectangular pattern.

Also, as used herein, the term “local” refers to the relationship of an item of interest (including, but not limited to, a measure of average amplitude, average noise energy or the derivation of a measure of weight), relative to pixel location level, and/or an item of interest corresponding to a pixel or a localized neighborhood of pixels within a picture.

Additionally, as used herein, the term “global” refers to the relationship of an item of interest (including, but not limited to, a measure of average amplitude, average noise energy or the derivation of a measure of weight) relative to picture level, and/or an item of interest corresponding to the totality of pixels of a picture or sequence.

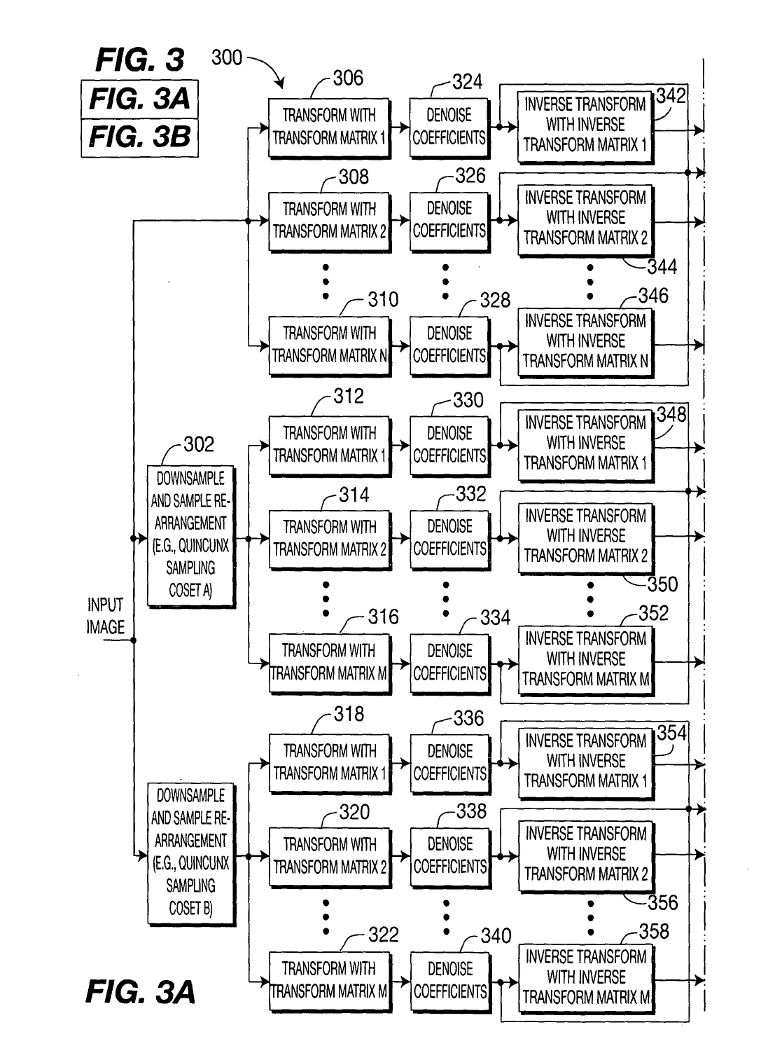

Turning to FIG. 3, an exemplary position adaptive sparsity based filter for pictures with multi-lattice signal transforms is indicated generally by the reference numeral 300.

A downsample and sample arrangement module 302 has an output in signal communication with an input of a transform module (with transform matrix 1) 312, an input of a transform module (with transform matrix 2) 314, and an input of a transform module (with transform matrix M) 316.

A downsample and sample rearrangement module 304 has an output in signal communication with an input of a transform module (with transform matrix 1) 318, an input of a transform module (with transform matrix 2) 320, and an input of a transform module (with transform matrix M) 322.

An output of the transform module (with transform matrix 1) 312 is connected in signal communication with an input of a denoise coefficients module 330. An output of the transform module (with transform matrix 2) 314 is connected in signal communication with an input of a denoise coefficients module 332. An output of the transform module (with transform matrix M) 316 is connected in signal communication with an input of a denoise coefficients module 334.

An output of the transform module (with transform matrix 1) 318 is connected in signal communication with an input of a denoise coefficients module 336. An output of the transform module (with transform matrix 2) 320 is connected in signal communication with an input of a denoise coefficients module 338. An output of the transform module (with transform matrix M) 322 is connected in signal communication with an input of a denoise coefficients module 340.

An output of a transform module (with transform matrix 1) 306 is connected in signal communication with an input of a denoise coefficients module 324. An output of a transform module (with transform matrix 2) 308 is connected in signal communication with an input of a denoise coefficients module 326. An output of a transform module (with transform matrix N) 310 is connected in signal communication with an input of a denoise coefficients module 328.

An output of the denoise coefficients module 324, an output of the denoise coefficients module 326, and an output of the denoise coefficients module 328 are each connected in signal communication with an input of an inverse transform module (with inverse transform matrix 1) 342, an input of an inverse transform module (with inverse transform matrix 2) 344, an input of an inverse transform module (with inverse transform matrix N) 346, and an input of a combination weights computation module 360.

An output of the denoise coefficients module 330, an output of the denoise coefficients module 332, and an output of the denoise coefficients module 334 are each connected in signal communication with an input of an inverse transform module (with inverse transform matrix 1) 348, an input of an inverse transform module (with inverse transform matrix 2) 350, an input of an inverse transform module (with inverse transform matrix M) 352, and an input of a combination weights computation module 362.

An output of the denoise coefficients module 336, an output of the denoise coefficients module 338, and an output of the denoise coefficients module 340 are each connected in signal communication with an input of an inverse transform module (with inverse transform matrix 1) 354, an input of an inverse transform module (with inverse transform matrix 2) 356, an input of an inverse transform module (with inverse transform matrix M) 358, and an input of a combination weights computation module 364.

An output of the inverse transform module (with inverse transform matrix 1) 342 is connected in signal communication with a first input of a combiner module 376. An output of the inverse transform module (with inverse transform matrix 2) 344 is connected in signal communication with a second input of the combiner module 376. An output of the inverse transform module (with inverse transform matrix N) 346 is connected in signal communication with a third input of the combiner module 376.

An output of the inverse transform module (with inverse transform matrix 1) 348 is connected in signal communication with a first input of an upsample, sample rearrangement and merge cosets module 368. An output of the inverse transform module (with inverse transform matrix 2) 350 is connected in signal communication with a first input of an upsample, sample rearrangement and merge cosets module 370. An output of the inverse transform module (with inverse transform matrix M) 352 is connected in signal communication with a first input of an upsample, sample rearrangement and merge cosets module 372.

An output of the inverse transform module (with inverse transform matrix 1) 354 is connected in signal communication with a second input of an upsample, sample rearrangement and merge cosets module 368. An output of the inverse transform module (with inverse transform matrix 2) 356 is connected in signal communication with a second input of an upsample, sample rearrangement and merge cosets module 370. An output of the inverse transform module (with inverse transform matrix M) 358 is connected in signal communication with a second input of an upsample, sample rearrangement and merge cosets module 372.

An output of the combination weights computation module 360 is connected in signal communication with a first input of a general combination weights computation module 374. An output of the combination weights computation module 362 is connected in signal communication with a first input of an upsample, sample rearrangement and merge cosets module 366. An output of the combination weights computation module 364 is connected in signal communication with a second input of an upsample, sample rearrangement and merge cosets module 366.

An output of the upsample, sample rearrangement and merge cosets module 366 is connected in signal communication with a second input of the general combination weights computation module 374. An output of the general combination weights computation module 374 is connected in signal communication with a fourth input of the combine module 376. An output of the upsample, sample rearrangement and merge cosets module 368 is connected in signal communication with a fifth input of the combiner module 376. An output of the upsample, sample rearrangement and merge cosets module 370 is connected in signal communication with a sixth input of the combiner module 376. An output of the upsample, sample rearrangement and merge cosets module 372 is connected in signal communication with a seventh input of the combiner module 376.

An input of the transform module (with transform matrix 1) 306, an input of the transform module (with transform matrix 2) 308, and input of the transform module (with transform matrix N) 310, an input of the downsample and sample arrangement module 302, and an input of the downsample and sample arrangement module 304 are available as input of the filter 300, for receiving an input image. An output of the combiner module 376 is available as an output of the filter 300, for providing an output picture.

Thus, the filter 300 provides processing branches corresponding to the non-downsampled processing of the input data and processing branches corresponding to the lattice-based downsampled processing of the input data. It is to be appreciated that the filter 300 provides a series of processing branches that may or may not be processed in parallel. It is further appreciated that while several different processes are described as being performed by different respective elements of the filter 300, given the teachings of the present principles provided herein, one of ordinary skill in this and related arts will readily appreciate that two or more of such processes may be combined and performed by a single element (for example, a single element common to two or more processing branches, for example, to allow re-use of non-parallel processing of data) and that other modifications may be readily applied thereto, while maintaining the spirit of the present principles. For example, in an embodiment, the combiner module 376 may be implemented outside the filter 300, while maintaining the spirit of the present principles.

Also, the computation of the weights and their use for blending (or fusing) the different filtered images obtained by processing them with the different transforms and sub-samplings, as shown in FIG. 3, may be performed in successive computation steps (as shown in the present embodiment) or may be performed in a single step at the very end by directly taking into account the amount of coefficients used to reconstruct each one of the pixels in each of the sub-sampling lattices and/or transforms.

Given the teachings of the present principles provided herein, one of ordinary skill in this and related arts will contemplate these and other variations of filter 300 (as well as filters 400 and 500 described herein below), while maintaining the spirit of the present principles.

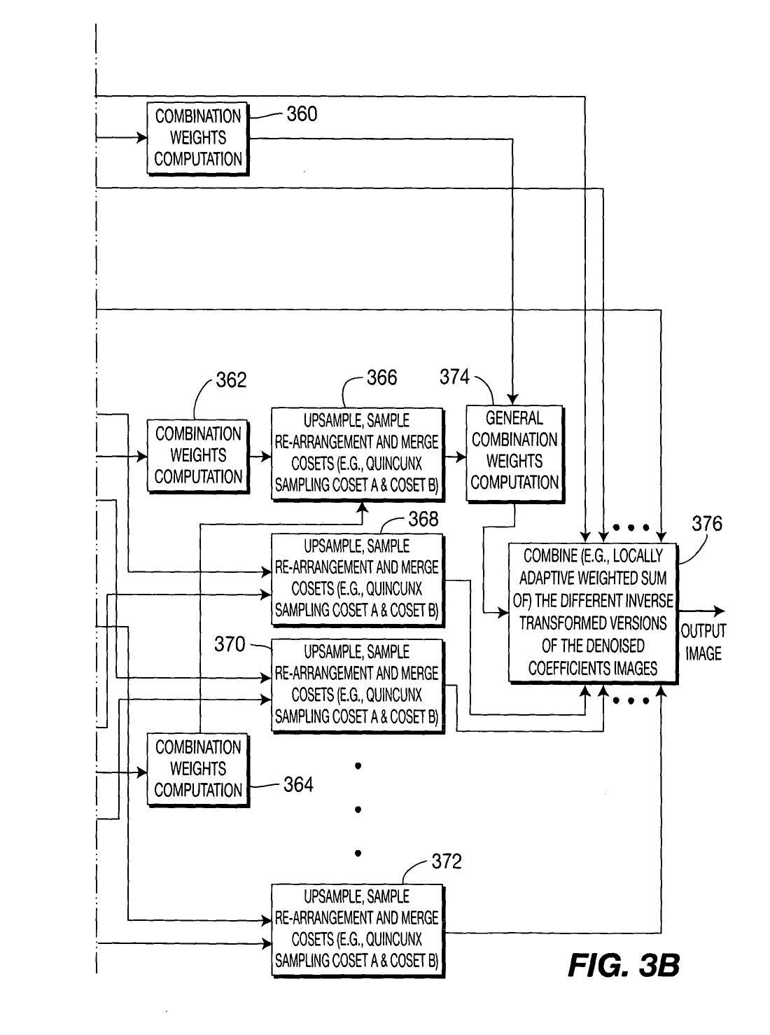

Turning to FIG. 4, another exemplary position adaptive sparsity based filter for pictures with multi-lattice signal transforms is indicated generally by the reference numeral 400. In comparison to the filter 300 of FIG. 3, the filter 400 of FIG. 4 utilizes switches so that the same transformation engine can be used in different sub-samplings of the signal in order to adapt the transform in use to have a wider range of structural properties for signal analysis. That is, in FIG. 4, a set of switches indicate that the same core transform domain processing unit may be used to compute all the necessary data for non-downsampled and downsampled processing as well as for the filtered estimates weighting procedure.

An output of a switch 406 is connected in signal communication with an input of a transform module (with transform matrix 1) 408, an input of a transform module (with transform matrix 2) 410, and an input of a transform module (with transform matrix N) 412.

An output of the transform module (with transform matrix 1) 408 is connected in signal communication with an input of a denoise coefficients module 414. An output of the transform module (with transform matrix 2) 410 is connected in signal communication with an input of a denoise coefficients module 416. An output of the transform module (with transform matrix N) 412 is connected in signal communication with an input of a denoise coefficients module 418.

An output of the denoise coefficients module 414 is connected in signal communication with an input of an inverse transform (with inverse transform matrix 1) 420, an input of an inverse transform (with inverse transform matrix 2) 422, an input of an inverse transform (with inverse transform matrix N) 424, and an input of a combination weights computation module 426.

An output of the inverse transform (with inverse transform matrix 1) 420 is connected in signal communication with an input of a switch 428. An output of the inverse transform (with inverse transform matrix 2) 422 is connected in signal communication with an input of a switch 430. An output of the inverse transform (with inverse transform matrix N) 424 is connected in signal communication with an input of a switch 432.

An output of the combination weights computation module 426 is connected in signal communication with an input of a switch 434. An output of the switch 434 is selectively connected in signal communication with a first input of an upsample, sample rearrangement and merge cosets module 436, a second input of the upsample, sample rearrangement and merge cosets module 436, and a first input of a general combination weights computation module 444. An output of the upsample, sample rearrangement and merge cosets module 436 is connected in signal communication with a second input of the general combination weights computation module 444. An output of the general combination weights computation module 444 is connected in signal communication with a first input of a combine module 446.

A first output of the switch 428 is connected in signal communication with a second input of the combiner module 446. A second output of the switch 428 is connected in signal communication with a second input of an upsample, sample arrangement and merge cosets module 438. A third output of the switch 428 is connected in signal communication with a third input of the upsample, sample arrangement and merge cosets module 438.

A first output of the switch 430 is connected in signal communication with a third input of the combiner module 446. A second output of the switch 430 is connected in signal communication with a second input of an upsample, sample arrangement and merge cosets module 440. A third output of the switch 430 is connected in signal communication with a third input of the upsample, sample arrangement and merge cosets module 440.

A first output of the switch 432 is connected in signal communication with a fourth input of the combiner module 446. A second output of the switch 432 is connected in signal communication with a second input of an upsample, sample arrangement and merge cosets module 442. A third output of the switch 432 is connected in signal communication with a third input of the upsample, sample arrangement and merge cosets module 442.

An output of the upsample, sample arrangement and merge cosets module 438 is connected in signal communication with a fifth input of the combiner module 446. An output of the upsample, sample arrangement and merge cosets module 440 is connected in signal communication with a sixth input of the combiner module 446. An output of the upsample, sample arrangement and merge cosets module 442 is connected in signal communication with a seventh input of the combiner module 446.

An output of a downsample and sample rearrangement module 402 is connected in signal communication with a second input of the switch 406. An output of a downsample and sample rearrangement module 404 is connected in signal communication with a third input of the switch 406.

A first input of the switch 406, an input of the downsample and sample rearrangement module 402, and an input of the downsample and sample rearrangement module 404 are each available as input of the filter 400, for receiving an input image. An output of the combine module 446 is available as an output of the filter 400, for providing an output image.

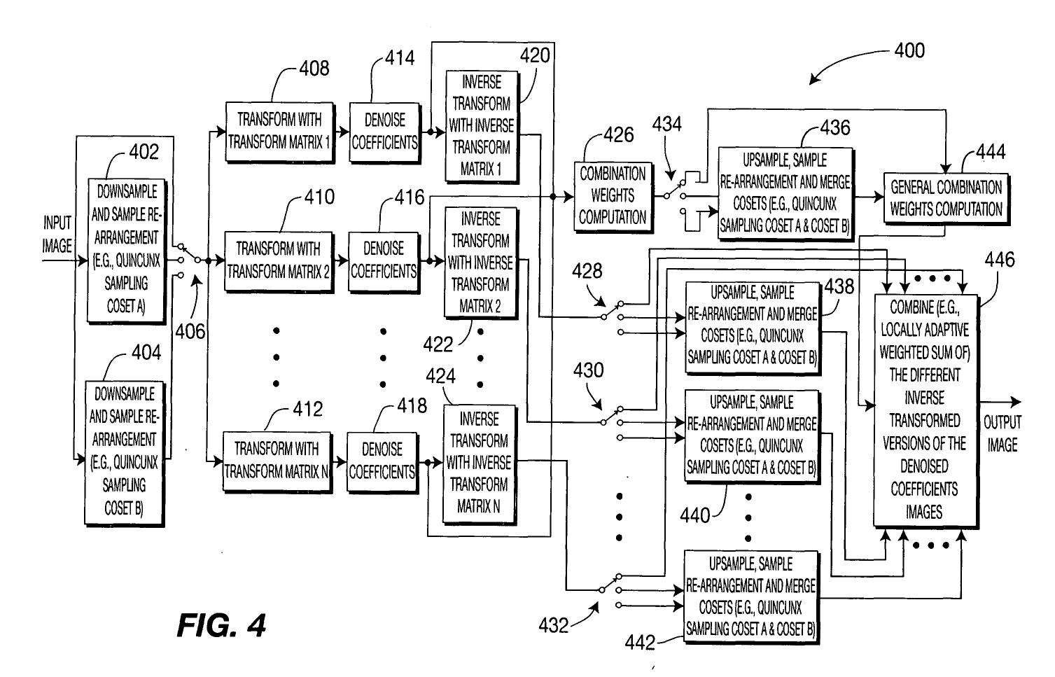

Turning to FIG. 5, yet another exemplary position adaptive sparsity based filter for pictures with multi-lattice signal transforms is indicated generally by the reference numeral 500. In the filter 500 of FIG. 5, a redundant set of transforms are packed into a single block. In FIG. 500, two possibly different sets of redundant transforms A and B are considered. Eventually, A and B may, or may not be the same redundant set of transforms.

An output of a downsample and sample rearrangement module 502 is connected in signal communication with an input of a forward transform module (with redundant set of transforms B) 508. An output of a downsample and sample rearrangement module 504 is connected in signal communication with an input of a forward transform module (with redundant set of transforms B) 510.

An output of a forward transform module (with redundant set of transforms A) 506 is connected in signal communication with a denoise coefficients module 512. An output of a forward transform module (with redundant set of transforms B) 508 is connected in signal communication with a denoise coefficients module 514. An output of a forward transform module (with redundant set of transforms B) 510 is connected in signal communication with a denoise coefficients module 516.

An output of denoise coefficients module 512 is connected in signal communication with an input of a computation of number of non-zero coefficients affecting each pixel module 526, and an input of an inverse transform module (with redundant set of transforms A) 518. An output of denoise coefficients module 514 is connected in signal communication with an input of a computation of number of non-zero coefficients affecting each pixel module 530, and an input of an inverse transform module (with redundant set of transforms B) 520. An output of denoise coefficients module 516 is connected in signal communication with an input of a computation of number of non-zero coefficients affecting each pixel module 532, and an input of an inverse transform module (with redundant set of transforms B) 522.

An output of the inverse transform module (with redundant set of transforms A) 518 is connected in signal communication with a first input of a combine module 536. An output of the inverse transform module (with redundant set of transforms B) 520 is connected in signal communication with a first input of an upsample, sample rearrangement and merge cosets module 524. An output of the inverse transform module (with redundant set of transforms B) 522 is connected in signal communication with a second input of an upsample, sample rearrangement and merge cosets module 524.

An output of the computation of number of non-zero coefficients affecting each pixel for each transform module 530 is connected in signal communication with a first input of an upsample, sample rearrangement and merge cosets module 528. An output of the computation of number of non-zero coefficients affecting each pixel for each transform module 532 is connected in signal communication with a second input of the upsample, sample rearrangement and merge cosets module 528.

An output of the upsample, sample rearrangement and merge cosets module 528 is connected in signal communication with a first input of a general combination weights computation module 534. An output of the computation of number of non-zero coefficients affecting each pixel 526 is connected in signal communication with a second input of a general combination weights computation module 534. An output of the general combination weights computation module 534 is connected in signal communication with a second input of the combine module 536.

An output of the upsample, sample rearrangement and merge cosets module 524 is connected in signal communication with a third input of a combine module 536.

An input of the forward transform module (with redundant set of transforms A) 506, an input of the downsample and sample rearrangement module 502, and an input of the downsample and sample rearrangement module 504 are each available as input of the filter 500, for receiving an input image. An output of the combine module 536 is available as an output of the filter, for providing an output image.

The filter 500 of FIG. 5, with respect to the filter 300 of FIG. 3, provides a significantly more compact implementation of the algorithm, packing the different transforms involved into a redundant representation of a picture into single box for simplicity and clearness. It is to be appreciated that transformation, denoising, and/or inverse transformation processes may, or may not, be carried out in parallel for each of the transforms included into a redundant set of transforms.

It is to be appreciated that the various processing branches shown in FIGS. 3-5 for filtering picture data, prior to combination weights calculation, may be considered to be version generators in that they generate different versions of an input picture.

As noted above, the present principles are directed to a method and apparatus for multi-lattice sparsity-based filtering.

In an embodiment of the present principles, a filtering strategy is provided wherein several lattices with different spatial orientations are sampled out of the regular rectangular sampling. Spatial lattice sampling can include, but it is not limited to, lattices such as the full rectangular sampling lattice and the quincunx sampling lattice. Then a filter using sparse approximations is applied using a given transform on each of the sampled lattices. The lattice sampling is in charge of diversifying the directions of the basis functions of the transform. Once all filtering steps have been performed on all the sampled lattices, these are recombined by means of a locally adaptive weighting step in order to give more weight to the most reliable filtered image version in every particular location.

The present principles solve the problem of directionality limitation of transforms by pre-sampling in an appropriate way the signal before filtering is applied. In this way, better filtering of images with smooth, high frequency features, textures, edges, and so forth, having an oriented characteristic (e.g., diagonal), can be achieved. Improved filtering can lead to better estimation of the ideal signal, implying a smaller distortion in both objective and subjective measures, lower coding costs in coding applications, and so forth.

In accordance with an embodiment of the present principles, a high-performance non-linear filter is proposed for images based on the weighted combination of several filtering steps on different sub-lattice samplings of the image to be filtered. Every filtering step is made through the sparse approximation of a lattice sampling of the image to be filtered. Sparse approximations allow for robust separation of true signal components from noise, distortion and artifacts. Depending on the signal and the sparse filtering technique, some signal areas are better filtered in one lattice and/or another lattice. The final weighting combination step allows for adaptive selection of the best filtered data from the most appropriate sub-lattice sampling.

Therefore, in accordance with the present principles, a high-performance non-linear filter for images based on the weighted combination of several filtering steps on different sub-lattice samplings of the image to be filtered is disclosed. The use of lattice-based transforms for the construction of direction adaptive filtering is considered. Thus, in a case where a particular type of distortion (or artifact) to be filtered has some directional structure, in accordance with an embodiment of the present principles, it is now possible to adaptively select the filter direction such that the distortion (or artifact) is not preserved.

### Oriented Transforms by Transformation of Lattice Sub-Samplings:

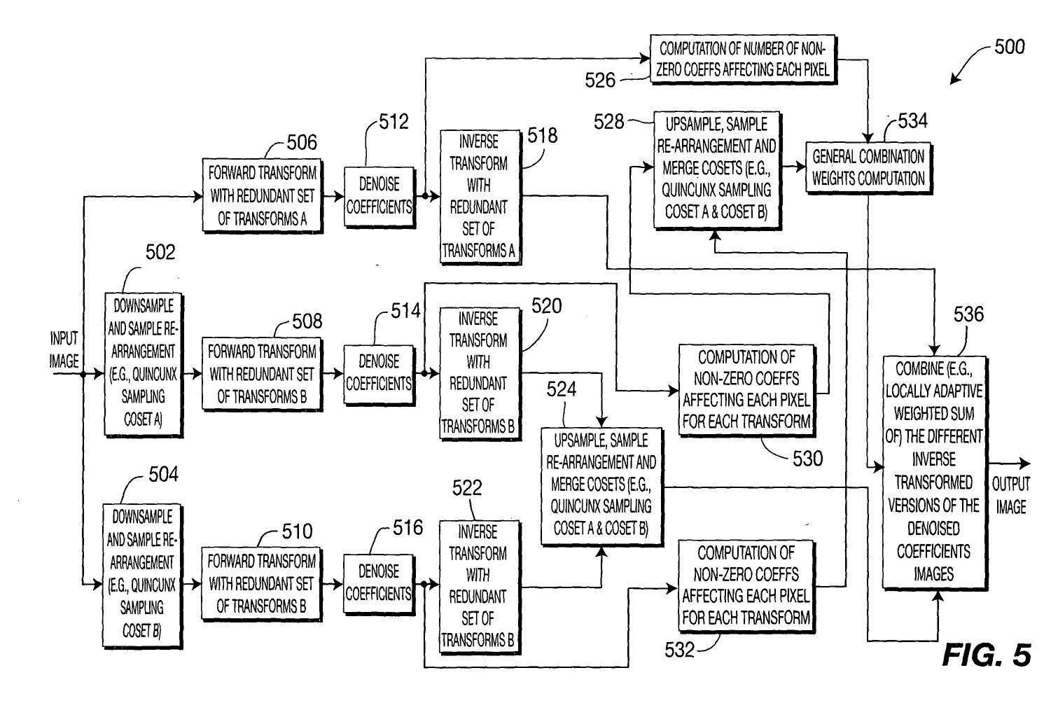

In general, transforms such as the Discrete Cosine Transform (DCT) decompose signals as a sum of primitives or basis functions. These primitives or basis functions have different properties and structural characteristics depending on the transform used. Turning to FIG. 6, Discrete Cosine Transform (DCT) basis functions and their shapes included in a DCT of 8×8 size are indicated generally by the reference numeral 600. As can be observed, basis functions 600 appear to have 2 main structural orientations. There are functions that are mostly vertically oriented, there are functions that are mostly horizontally oriented, and there are functions that are a kind of checkerboard-like mixture of both. These shapes are appropriate for efficient representation of stationary signals as well as of vertically and horizontally shaped signal components. However, parts of signals with oriented properties are not efficiently represented by such a transform. In general, like the DCT example, most transform basis functions have a limited variety of directional components.

One way to modify the directions of decomposition of a transform is to use such a transform in different sub-samplings of a digital image. Indeed, one can decompose 2D sampled images in complementary sub-sets (or cosets) of pixels. These cosets of samples can be done according to a given sampling pattern. Sub-sampling patterns can be established such that they are oriented. These orientations imposed by the sub-sampling pattern combined with a fixed transform can be used to adapt the directions of decomposition of a transform into a series of desired directions.

In an embodiment of image sub-sampling, one can use integer lattice sub-sampling where the sampling lattice can be represented by means of a non-unique generator matrix. Any lattice [symbol] , sub-lattice of the cubic integer lattice [symbol] ², can be represented by a non-unique generator matrix:

$${M}_{A} = [ \begin{matrix}{a}_{1} & {b}_{1} \\ {a}_{2} & {b}_{2}\end{matrix} ] = [ \begin{matrix}{d}_{1} \\ {d}_{2}\end{matrix} ] , \\ where {a}_{1} , {a}_{2} , {b}_{1} , {b}_{2} ∈ ℤ .$$

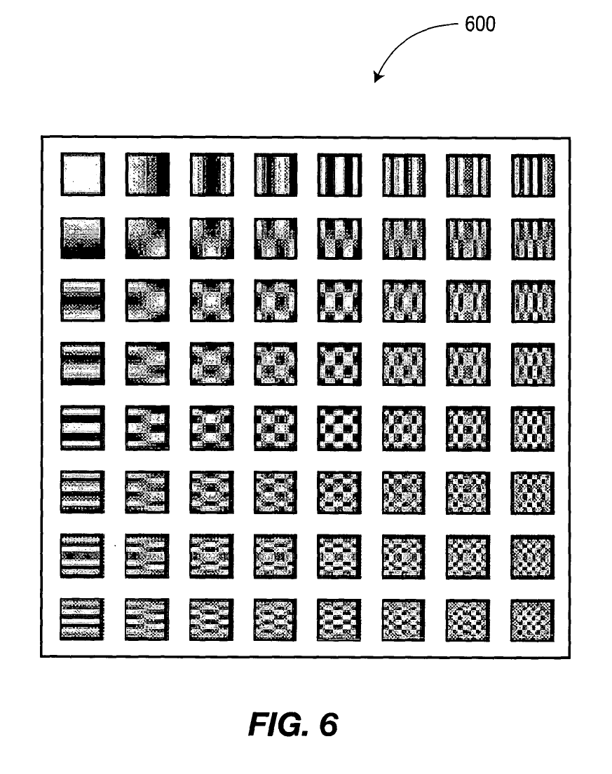

The number of complementary cosets is given by the determinant of the matrix above. Also, d₁ d₂ can be related to the main directions of the sampling lattice in a 2D coordinate plane. Turning to FIGS. 7A and 7B, examples of lattice sampling with corresponding lattice sampling matrices, to which the present principles may be applied, is indicated generally by the reference numerals 700 and 750, respectively. In FIG. 7A, a quincunx lattice sampling is shown. One of two cosets relating to the quincunx lattice sampling is shown in black (filled-in) dots. The complementary coset is obtained by a 1-shift in the direction of the x/y axis. In FIG. 7B, another directional lattice sampling is shown. Two of the four possible cosets are shown in black and white dots. Arrows depict the main directions of the lattice sampling. One of ordinary skill in this and related arts can appreciate the relationship between the lattice matrices and the main directions (arrows) on the lattice sampling.

The generator matrix is the mapping matrix between both sampling spaces, e.g., the oriented quincunx, and the regular rectangular grid. One can observe that there is an implicit rotation between the coordinate axes of one sampling lattice with respect to the full lattice. The mapping between both sampling lattices can be, thus, expressed as follows:

$$[ \begin{matrix}{x}_{rec} \\ {y}_{rec}\end{matrix} ] = [ \begin{matrix}{a}_{1} & {b}_{1} \\ {a}_{2} & {b}_{2}\end{matrix} ] \cdot [ \begin{matrix}{x}_{qx} \\ {y}_{qx}\end{matrix} ] + {\overline{s}}_{i}^{t} ,$$

where

$$[ \begin{matrix}{x}_{rec} \\ {y}_{rec}\end{matrix} ]$$

are the sample coordinates in the rectangular grid and

$$[ \begin{matrix}{x}_{qx} \\ {y}_{qx}\end{matrix} ]$$

are the sample coordinates in the lattice grid (e.g. quincunx), and where \vec{s}ᵢ^{l} represents a shift vector (as exemplified in FIG. 7) in order to select each of the complementary coset lattices associated to the generator matrix. Depending on the matrix, there will be more or less shift vectors.

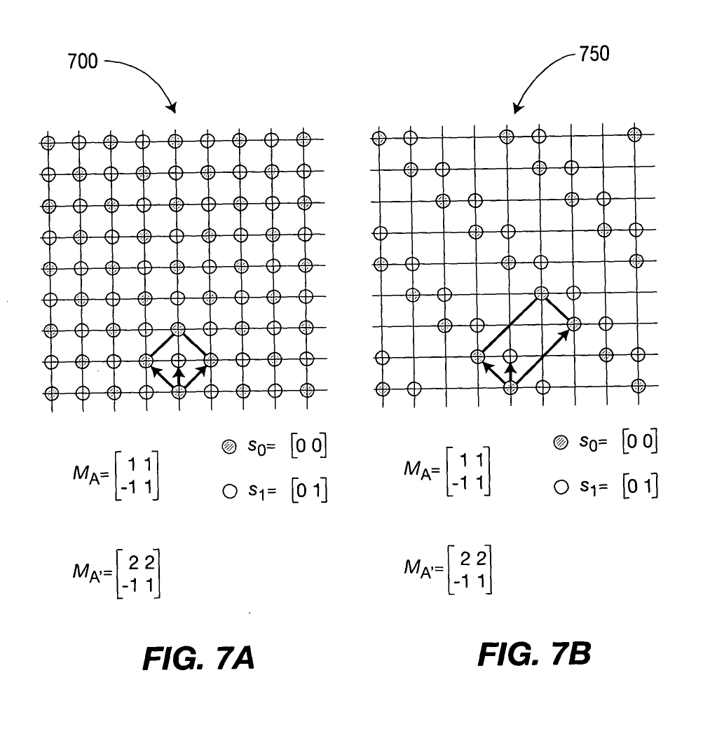

Every coset in any of such a sampling lattice is aligned in such a way that can be totally rearranged (e.g., rotated) in a down-sampled rectangular grid. This allows for the subsequent application of any transform suitable for a rectangular grid (such as the 2D DCT) on the lattice sub-sampled signal. Turning to FIG. 8, an exemplary down-sampled rectangular grid to which every coset in any such sampling lattice may be re-arranged is indicated generally by the reference numeral 800.

The combination of lattice decomposition, lattice re-arrangement, 2D transformation, and the respective set of inverse operations allows for the implementation of 2D signal transformations with arbitrary orientations.

### Multiple-Lattice Picture Processing for Orientation Adaptive Filtering:

In an embodiment, the use of at least two samplings of a picture is proposed for adaptive filtering of pictures. In an embodiment, a same filtering strategy such as DCT coefficients thresholding can be reused and generalized for direction adaptive filtering.

One of the at least two lattice samplings/sub-samplings can be, for example, the original sampling grid of a given picture (i.e., no sub-sampling of the picture). In an embodiment, another of the at least two samplings can be the so called “quincunx” lattice sub-sampling. Such a sub-sampling is composed by 2 cosets of samples disposed on diagonally aligned samplings of every other pixel.

In an embodiment, the combination of the at least two lattice samplings/sub-samplings is used in this invention for adaptive filtering, as depicted in FIGS. 9, 3, and 4.

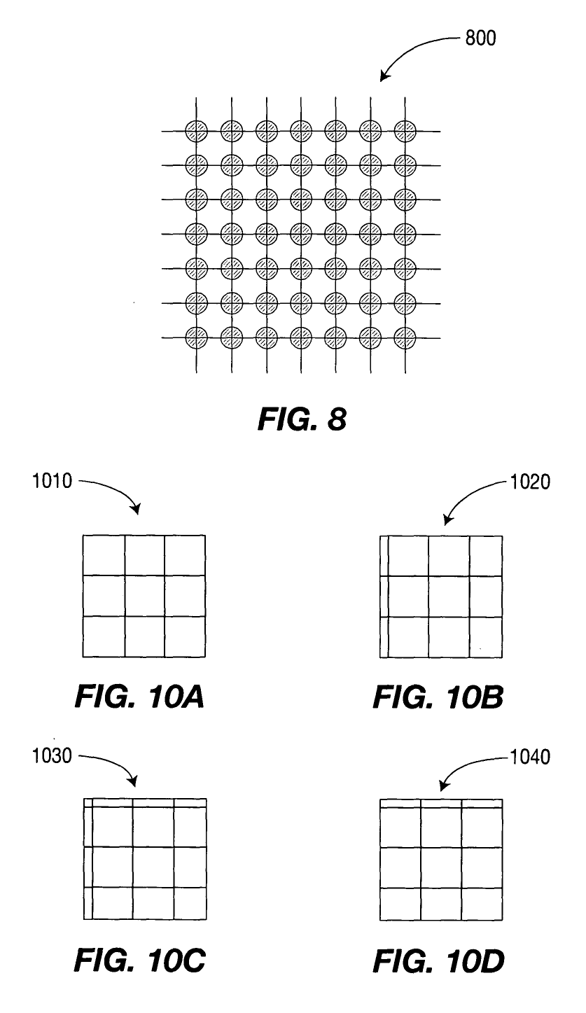

Turning to FIG. 9, an exemplary method for position adaptive sparsity based filtering of pictures with multi-lattice signal transforms is indicated generally by the reference numeral 900. The method 900 of FIG. 9 corresponds to the application of sparsity-based filtering in the transformed domain on a series of re-arranged integer lattice sub-samplings of a digital image.

The method 900 includes a start block 905 that passes control to a function block 910. The function block 910 sets the shape and number of possible families of sub-lattice image decompositions, and passes control to a loop limit block 915. The loop limit block 915 performs a loop for every family of (sub-)lattices, using a variable j, and passes control to a function block 920. The function block 920 downsamples and splits an image into N sub-lattices according to family of sub-lattices j (the total number of sub-lattices depends on every family j), and passes control to a loop limit block 925. The loop limit block 925 performs a loop for every sub-lattice, using a variable k (the total amount depends on the family j), and passes control to a function block 930. The function block 930 re-arranges samples (e.g., from arrangement A(j,k) to B), and passes control to a loop limit block 935. The loop limit block 935 performs a loop for every value of a variable i, and passes control to a function block 940. The function block 940 performs a transform with transform matrix i, and passes control to a function block 945. The function block 945 filters the coefficients, and passes control to a function block 950. The function block 950 performs an inverse transform with inverse transform matrix i, and passes control to a loop limit block 955. The loop limit block 955 ends the loop over each value of variable i, and passes control to a function block 960. The function block 960 re-arranges samples (from arrangement B to A(j,k)), and passes control to a loop limit block 965. The loop limit block 965 ends the loop over each value of variable k, and passes control to a function block 970. The function block 970 upsamples and merges sub-lattices according to family of sub-lattices j, and passes control to a loop limit block 975. The loop limit block 975 ends the loop over each value of variable j, and passes control to a function block 980. The function block 980 combines (e.g., locally adaptive weighted sum of) the different inverse transformed versions of the denoised coefficients images, and passes control to an end block 999.

With respect to FIG. 9, it can be seen that in an embodiment, a series of filtered pictures are generated by the use of transformed domain filtering that, in turn, uses different transforms in different sub-samplings of the picture. The final filtered image is computed as the locally adaptive weighted sum of each of the filtered pictures.

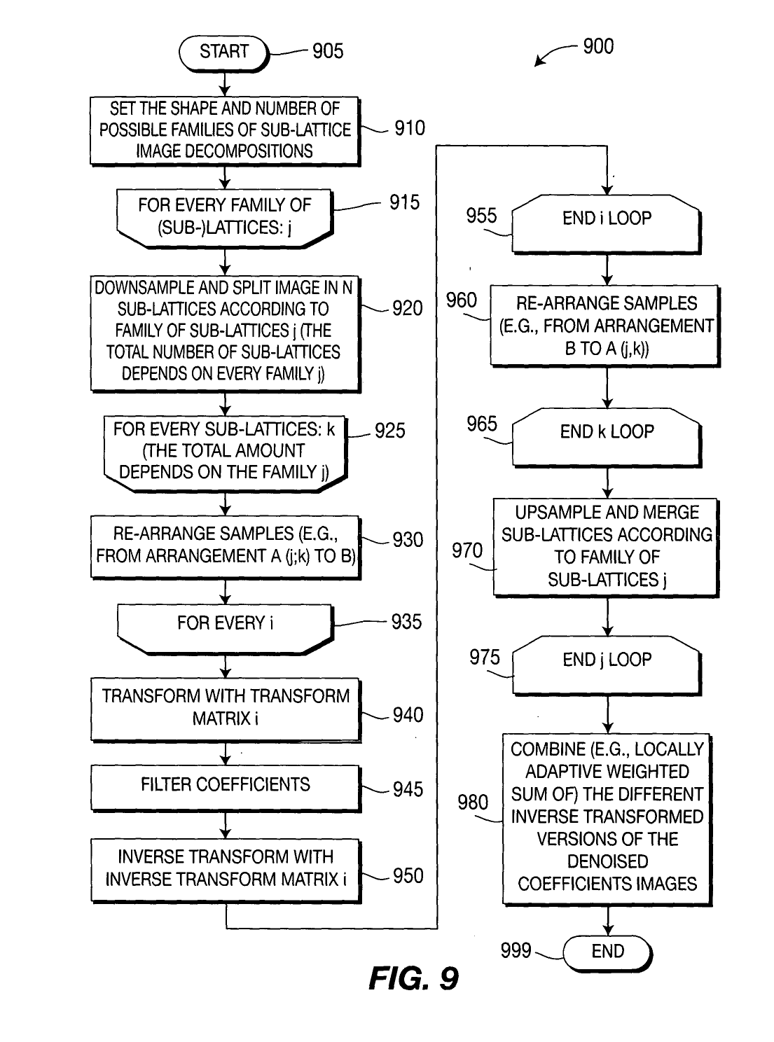

In an embodiment, the set of transforms applied to any re-arranged integer lattice sub-sampling of a digital image is formed by all the possible translations of a 2D DCT. This implies that there are a total of 16 possible translations of a 4×4 DCT for the block based partitioning of a picture for DCT block transform. In the same way, 64 would be the total number of possible translations of an 8×8 DCT. An example of this can be seen in FIGS. 10A-10D. Turning to FIGS. 10A-10D, exemplary possible translations of block partitioning for DCT transformation of an image is indicated generally by the reference numerals 1010, 1020, 1030, and 1040, respectively. FIGS. 10A-10D respectively show one of four of the 16 possible translations of a 4×4 DCT transform. Incomplete boundary blocks, smaller than the transform size, can be virtually extended for example using some padding or image extensions. Partitions that are smaller than the transform size, on the boundaries of the picture, can be virtually extended by means of padding or some sort of picture extension. This allows for the use of the same transform size in all the image blocks. FIG. 9 indicates that such a set of translated DCTs are applied in the present example to each of the sub-lattices (each of the 2 quincunx cosets in the present example).

In an embodiment, the filtering process can be performed at the core of the transformation stage by thresholding the transformed coefficients of every translated transform of every lattice sub-sampling. The threshold value used for such a purpose may depend on, but is not limited to, one or more of the following: local signal characteristics, user selection, local statistics, global statistics, local noise, global noise, local distortion, global distortion, statistics of signal components pre-designated for removal, and characteristics of signal components pre-designated for removal. After the thresholding step, every transformed lattice sub-sampling is inverse transformed. Every set of complementary cosets are rotated back to their original sampling scheme, upsampled and merged in order to recover the original sampling grid of the original picture. In the particular case where transforms are directly applied to the original sampling of the picture, no rotation, upsampling and sample merging is required.

Finally, according to FIG. 9, all the different filtered pictures are blended into one picture by the weighted addition of all of them. This is done in the following way. Let I′ᵢ be each of the different images filtered by thresholding, and where each I′ᵢ may correspond to any of the reconstructed pictures after thresholding of a translation of a DCT of any of the pictures that have or not undergone sub-sampling during the filtering process. Let Wᵢ be a picture of weights where every pixel contains a weight associated to its co-located pixel in I′ᵢ. Then the final estimate I′_{final} is obtained as follows:

$${I}_{final}^{′} ( x , y ) = {\sum }_{i} {I}_{i}^{′} ( x , y ) \cdot {W}_{i} ( x , y ) ,$$

where x and y represent the spatial coordinates.

In order to compute Wᵢ(x, y), one can do it such that when used within the previous equation, at every location, the I′ᵢ(x, y) having a local sparser representation in the transformed domain has a greater weight. This comes from the presumption that the I′ᵢ(x, y) obtained from the sparser of the transforms after thresholding includes the lowest amount of noise/distortion. In an embodiment, Wᵢ(x, y) matrices are generated for every I′ᵢ(x, y) (those obtained from the non-sub-sampled filterings and for lattice sub-sampled based filtering). Wᵢ(x, y) corresponding to I′ᵢ(x, y) that have undergone a lattice sub-sampling procedure are obtained by means of the generation of an independent W_{i,coset(j)}(x, y) for every filtered sub-sampled image (i.e. before the procedure of rotation, upsampling and merging), and then the different W_{i,coset(j)})(x, y) corresponding to a I′ᵢ(x, y) are rotated, up-sampled and merged in the same way as it is done to recompose I′ᵢ(x, y) from its complementary sub-sampled components. Hence, in an example, every filtered image having undergone, during the filtering process, a quincunx sub-sampling, would have 2 weight sub-sampled matrices. These can then be rotated, upsampled and merged into one single weighting matrix to be used with its corresponding I′ᵢ(x, y).

In an embodiment, the generation of each W_{i,coset(j)}(x, y) is performed in the same way as for Wᵢ(x, y). Every pixel is assigned a weight that is derived from the amount of non-zero coefficients of the block transform where such a pixel is comprised. In an example, the weights of W_{i,coset(j)}(x, y) (and Wᵢ(x, y) as well) can be computed for every pixel such that they are inversely proportional to the amount of non-zero coefficients within the block transform that comprises each of the pixels. According to this approach, weights in Wᵢ(x, y) have the same block structure as the transforms used to generate I′ᵢ(x, y).

Exemplary applications of the Multi-lattice Sparsity-Based Filtering include, but are not limited to, the following: picture denoising, picture de-artifacting, some other post-processing purpose; in-loop filtering for de-artifacting within video encoders/decoders; pre-processing video data for film grain removal; and so forth.

A description will now be given of some of the many attendant advantages/features of the present invention, some of which have been mentioned above. For example, one advantage/feature is an apparatus having a filter for filtering picture data for a picture to generate an adaptive weighted combination of at least two filtered versions of the picture. The picture data includes at least one sub-sampling of the picture.

Another advantage/feature is the apparatus having the filter as described above, wherein at least one of the at least two filtered versions of the picture is generated by applying the filter to the at least one sub-sampling of the picture. The at least one sub-sampling of the picture includes at least one two-dimensional pattern of values representative of at least a portion of the picture.

Yet another advantage/feature is the apparatus having the filter as described above, wherein the picture data comprises two different samplings of the picture, and the filter is applied to the at least two different samplings of the picture to generate the at least two filtered versions of the picture. The at least two different samplings include the at least one sub-sampling of the picture.

Still another advantage/feature is the apparatus having the filter as described above, wherein the filter is at least one of linear and non-linear.

Moreover, another advantage/feature is the apparatus having the filter as described above, wherein the picture data is transformed into coefficients, and the filter filters the coefficients in a transformed domain based on signal sparsity constraints.

Further, another advantage/feature is the apparatus having the filter that filters the coefficients in a transformed domain based on signal sparsity constraints as described above, wherein the adaptive weighted combination is based on a measure of sparseness of the filtered coefficients in the transformed domain.

Also, another advantage/feature is the apparatus having the filter that filters the coefficients in a transformed domain based on signal sparsity constraints as described above, wherein the transformed domain is responsive to at least one of at least a redundant transform and at least a set of transforms.

Additionally, another advantage/feature is the apparatus having the filter that filters the coefficients in a transformed domain based on signal sparsity constraints as described above, wherein the coefficients are filtered in the transformed domain using at least one threshold.

Moreover, another advantage/feature is the apparatus having the filter that filters the coefficients in the transformed domain using at least one threshold as described above, wherein the at least one threshold is locally adaptive depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, statistics of signal components of an input signal that includes the picture data and characteristics of the signal components of the input signal that includes the picture data.

Further, another advantage/feature is the apparatus having the filter as described above, wherein the apparatus is included within a video encoder.

Also, another advantage/feature is the apparatus having the filter as described above, wherein the apparatus is included within a video decoder.

Additionally, another advantage/feature is the apparatus having the filter as described above, wherein the at least one two-dimensional pattern of values includes at least one two-dimensional geometric pattern representative of at least a portion of the picture.

Moreover, another advantage/feature is the apparatus having the filter as described above, wherein the filter includes a version generator, a weights calculator, and a combiner. The version generator is for generating the at least two filtered versions of the picture. The weights calculator is for calculating the weights for each of the at least two filtered versions of the picture. The combiner is for adaptively calculating the adaptive weighted combination of the at least two filtered versions of the picture.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a filter for filtering picture data for a picture to generate an adapted weighted combination of at least two filtered versions of the picture, the picture data including at least one sub-sampling of the picture.

2. The apparatus of claim 1, wherein at least one of the at least two filtered versions of the picture is generated by applying the filter to the at least one sub-sampling of the picture, the at least one sub-sampling of the picture comprising at least one two-dimensional pattern of values representative of at least a portion of the picture.

3. The apparatus of claim 1, wherein the picture data comprises two different samplings of the picture, and said filter is applied to the at least two different samplings of the picture to generate the at least two filtered versions of the picture, the at least two different samplings including the at least one sub-sampling of the picture.

4. The apparatus of claim 1, wherein the picture data is transformed into coefficients, and said filter filters the coefficients in a transformed domain based on signal sparsity constraints.

5. The apparatus of claim 4, wherein the adapted weighted combination is based on a measure of sparseness of the filtered coefficients in the transformed domain.

6. The apparatus of claim 4, wherein the coefficients are filtered in the transformed domain using at least one threshold.

7. The apparatus of claim 6, wherein the at least one threshold is locally adapted depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, statistics of signal components of an input signal that includes the picture data and characteristics of the signal components of the input signal that includes the picture data.

8. The apparatus of claim 1, wherein the apparatus is comprised within a video encoder.

9. The apparatus of claim 1, wherein the apparatus is comprised within a video decoder.

10. The apparatus of claim 1, wherein said filter comprises:
a version generator for generating the at least two filtered versions of the picture;
a weights calculator for calculating the weights for each of the at least two filtered versions of the picture; and
a combiner for calculating the adapted weighted combination of the at least two filtered versions of the picture.

11. A method, comprising:
filtering picture data for a picture to generate at least two filtered versions of the picture, the picture data including at least one sub-sampling of the picture; and
calculating an adapted weighted combination of the at least two filtered versions of the picture.

12. The method of claim 11, wherein at least one of the at least two filtered versions of the picture is generated by filtering the at least one sub-sampling of the picture, and the at least one sub-sampling of the picture comprises at least one two-dimensional pattern of values representative of at least a portion of the picture.

13. The method of claim 11, wherein the picture data comprises two different samplings of the picture, and the at least two filtered versions of the picture are generated by filtering the two different samplings of the picture, the at least two different samplings including the at least one sub-sampling of the picture.

14. The method of claim 11, wherein the picture data is transformed into coefficients, and said filtering step filters the coefficients in a transformed domain based on signal sparsity constraints.

15. The method of claim 14, wherein the adapted weighted combination is based on a measure of sparseness of the filtered coefficients in the transformed domain.

16. The method of claim 14, wherein the transformed domain is responsive to at least one of at least a redundant transform and at least a redundant set of transforms.

17. The method of claim 14, wherein the coefficients of the picture are filtered in the transformed domain using at least one threshold.

18. The method of claim 17, wherein the at least one threshold is locally adapted depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, statistics of signal components of an input signal that includes the picture data, and characteristics of the signal components of the input signal that includes the picture data.

19. The method of claim 11, wherein the method is performed within a video encoder.

20. The method of claim 11, wherein the method is performed within a video decoder.

21. The method of claim 11, wherein the at least one two-dimensional pattern of values comprises at least one two-dimensional geometric pattern of values representative of at least the portion of the picture.

22. The method of claim 11, wherein said at least one filter comprises calculating the weights for each of the at least two filtered versions of the picture.
